(19) United States
(12) Patent Application Publication
(10) Pub. No.: US 2026/0350670 A1
(43) Pub. Date: Nov. 5, 2026

(54) Service Request Routing and Trust-Bound Execution for Buyer-Initiated Task Completion

(71) Applicant: ADRIAN FARIAS JARAMILLO, JURUPA VALLEY, CA (US)

(72) Inventor: ADRIAN FARIAS JARAMILLO, JURUPA VALLEY, CA (US)

(21) Appl. No.: 19/336,042

(22) Filed: Sep. 22, 2025

Related U.S. Application Data
(63) Continuation of application No. 19/197,894, filed on May 2, 2025.
(60) Provisional application No. 63/786,937, filed on Apr. 10, 2025.
(60) Provisional application No. 63/787,944, filed on Apr. 13, 2025.
(60) Provisional application No. 63/788,834, filed on Apr. 15, 2025.
(60) Provisional application No. 63/791,534, filed on Apr. 20, 2025.
(60) Provisional application No. 63/792,918, filed on Apr. 23, 2025.

(51) Int. Cl. G06Q 30/0601; G06Q 10/083

(52) U.S. Cl. CPC G06Q 30/0611; G06Q 10/083

(57) ABSTRACT

A system for routing and executing buyer-initiated service tasks within a sealed commercial platform. Providers are matched by license, trust score, and jurisdictional fit. Execution is locked to on-platform rails, with escrow, metadata logging, and compliance enforcement to ensure trust-bound fulfillment integrity.

### CROSS-REFERENCE TO RELATED APPLICATIONS

This application is a continuation of U.S. Utility patent application Ser. No. 19/197,894, filed May 2, 2025, which claims the benefit of the following U.S. Provisional Patent Applications, each of which is incorporated herein by reference in its entirety:
U.S. Provisional Application No. 63/786,937, filed Apr. 10, 2025, titled “System and Method for Buyer-Initiated Marketplace Transactions Across Multiple Industries”
U.S. Provisional Application No. 63/787,944, filed Apr. 13, 2025, titled “Sealed Toolset and Logic Framework for Buyer-Initiated Offer Systems”
U.S. Provisional Application No. 63/788,834, filed Apr. 15, 2025, titled “Toolset Protection for Modular Buyer-Initiated Offer Ecosystem”
U.S. Provisional Application No. 63/791,534, filed Apr. 20, 2025, titled “Modular Toolset Architecture for Multi-Sector Buyer-Initiated Commerce Infrastructure”
U.S. Provisional Application No. 63/792,918, filed Apr. 23, 2025, titled “Lockdown: Final Enforcement Tools for Global Buyer-Initiated Transaction Control”

### FIELD OF THE INVENTION

The present invention relates to the execution of buyer-initiated service requests and more specifically to a system that ensures routing, validation, and trust-bound fulfillment of service tasks within a sealed platform infrastructure.

### BACKGROUND OF THE INVENTION

Traditional service marketplaces allow for open bids, inconsistent service tiers, and unreliable provider execution. Buyer requests often lack structured protection, leading to fraud, delays, or miscommunication.

Current systems do not ensure that service providers are platform-licensed, trust-cleared, or matched to a verified inventory of executable service tasks.

There is a need for a platform-native execution logic that routes service requests based on buyer triggers, matches against verified provider capabilities, and locks fulfillment to a sealed commercial path.

### SUMMARY OF THE INVENTION

The invention enables trusted, platform-verified service execution in response to buyer-initiated triggers.

Upon request input, the system identifies service categories, cross-references available licensed providers, and routes the task through a gated execution protocol.

Providers are only eligible if they hold an active platform license, maintain a sufficient trust score, and accept escrow and jurisdictional filters.

Fulfillment execution includes digital confirmations, audit trails, and real-time task monitoring.

Unauthorized service fulfillment—whether by unlicensed, unverified, or external providers—is automatically rejected and flagged.

### DETAILED DESCRIPTION OF THE INVENTION

The system includes a buyer interface, service logic engine, provider verification system, escrow module, and sealed execution controller.

A buyer initiates a task request by submitting structured or natural language input to the platform.

The request is parsed to identify task type, urgency, jurisdiction, and licensing class.

Providers eligible for the task are filtered by active license tokens, service capability metadata, trust score minimums, and location availability.

Escrow terms are issued and must be accepted before execution begins.

The system logs execution metadata including timestamps, session IDs, and compliance status.

Fulfillment occurs only via platform-bound interfaces, prohibiting off-platform execution or external contracting.

All actions are verified against platform compliance rules including local regulations, payment protections, and audit visibility.

If fulfillment conditions change mid-task (e.g., license lapse, location error), the system halts execution until reauthorization.

What is claimed is:

1. A service execution system comprising:
a buyer request interface;
a provider verification engine;
an escrow module;
and a sealed fulfillment controller that activates service delivery only upon verified match and trust clearance.

2. The system of claim 1, wherein provider eligibility requires an active platform license and trust score above a platform-defined threshold.

3. The system of claim 1, wherein the fulfillment controller locks execution to on-platform tools and denies off-platform engagement.

4. A method comprising:
receiving a service request from a buyer;
classifying task category and jurisdiction;
filtering eligible providers by license and trust score;
and executing fulfillment through platform-tethered rails.

5. The system of claim 1, wherein escrow is required and linked to provider authorization before task commencement.

6. The method of claim 4, wherein task routing includes jurisdictional filtering and metadata scoring.

7. The system of claim 1, wherein fulfillment logs include timestamps, session IDs, provider license tokens, and trust evaluation history.

8. The method of claim 4, wherein provider trust score is recalculated dynamically based on behavioral metrics and platform activity.

9. A sealed execution rail comprising:
task classification logic;
provider matching engine;
escrow gating;
and jurisdiction-aware compliance filters.

10. The method of claim 4, wherein service request fulfillment is denied upon detection of unauthorized or unlicensed provider activity.

11. A compliance enforcement module comprising:
fulfillment attempt scanner, license verifier, and rejection trigger.

12. The system of claim 1, wherein digital contract acceptance and confirmation is required prior to task authorization.

13. A provider-side execution module configured to confirm task receipt, validate license, and send completion data to the audit log.

14. The method of claim 4, wherein buyers receive real-time status updates and audit trail access during fulfillment.

15. A trust decay prevention logic that restricts future task eligibility based on fulfillment integrity history.

16. A method comprising:
monitoring ongoing service tasks;
halting execution upon license expiry or trust breach;
and triggering provider re-verification.

17. A platform-locked service grid wherein all buyer-initiated tasks are matched, routed, executed, and logged within the sealed infrastructure.

18. The system of claim 1, wherein third-party integrations are limited to those holding platform-tied execution certification.

19. A buyer-side notification engine that alerts of provider eligibility status and estimated task routing time.

20. A sealed platform execution engine configured to route, verify, and fulfill service tasks using trust-based authorization protocols.
